(19) United States
(12) Patent Application Publication
(10) Pub. No.: US 2011/0212285 A1
(43) Pub. Date: Sep. 1, 2011

(54) Removable oquaque coating provided on a pressure sensitive piggyback label intermediate configuration and package containing same

(75) Inventor: Roger D. Buck, Pittsburg, KS (US)

(73) Assignee: Ward / Kraft, Inc.

(21) Appl. No.: 12/660,586

(22) Filed: Mar. 1, 2010

(51) Int. Cl. G09F 3/10; G09F 3/02; B42D 15/00

(52) U.S. Cl. 428/41.8; 283/81; 283/102

(57) ABSTRACT

The present invention is a pressure sensitive intermediate assembly that can be produced in a number of continuous configurations that may be used by small business owners, non-profits and other similarly situated groups. The intermediate assembly has a series of individual printed portions on the substrate of each roll or rolls. Each of the printed portions are covered with a removable opaque coating and the printed portions may be imaged with motivational, promotional, sweepstakes and similar messages. The recipient of the roll or package containing several rolls may separate individual label portions and create distinct business communications at a location that is separate from the manufacturing site. The assembly of the present invention allows small office and business owners to create communication products which were previously unavailable except in large quantities.

### CROSS-REFERENCES TO RELATED APPLICATIONS

None.

### FIELD OF THE INVENTION

The present invention relates to a pressure sensitive piggyback label intermediate configuration and a package containing a series of such intermediates that may be used by small business owners to create specialty business communication products. More specifically, the instant specification is directed toward describing a pressure sensitive intermediate assembly that may be utilized in one or more configurations to create a unique office product that has a message which may be revealed by individual users or recipients such as through the use of abrasive activity to remove an opaque coating covering the printed or imaged message. The intermediate assembly may be provided in a roll configuration that allows the small business owner to remove individual pressure sensitive portions and apply the labels to distinct business form assemblies that may be used in the business.

In addition, the instant invention includes a package that includes one or more rolls of product to provide some level of variability of the offering. Each of the rolls provided in such package may contain distinct printed information allowing the user to select the particular message that is being used in connection with the offering. The pressure sensitive intermediate assembly allows business communication products to be assembled at a location that is separate and distinct from the original manufacturing location thereby enabling small office and business operators to have greater flexibility in providing communication products to its end users.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and information handling needs of businesses and consumers alike.

The market for printed materials is also changing and becoming significantly more sophisticated. Conventional business forms manufacturers have normally produced product runs that range in the hundreds of thousands to millions or even tens of millions of pieces for a single order. Purchasing products at these production levels has often been out of reach by small business owners primarily due to quantity requirements as well as the associated costs of such large orders. In addition, such large production runs often were devoid of any special or unique features as economies of scale were achieved by manufacturers in generating large quantities of relatively indiscreet product. In addition, the historical marketplace may simply not have demanded as much in the way of features produced in smaller production runs as volume simply did not justify such manufacturing capabilities.

A still further drawback of trying to migrate to smaller or individualized customer applications that include special features and characteristics relate to quality of the pieces that need to be generated. With the focus of the market shifting to smaller runs and the level of personalization increasing, the end user is now demanding greater product performance than that typically associated with conventionally printed products as well as the need to create products that have varying degrees of personalization. Thus, the manufacturer may simply not be able to add personalized or special features to the printed communications and still retain a reasonable expectation of profits while maintaining a price level that can still be obtained by small business owners.

It is believed that one of the reasons for such far reaching changes in the printing industry is that end users want more from each piece that is produced rather than relying on the quantity of pieces to generate the desired result. In addition, marketers want to make a greater impact at every turn in the retail chain to try and maximize the chances for purchases of a particular product being offered by the printed piece. This demand must be weighed in combination with the increasing demands associated with being able to produce products in an economical and efficient manner.

With the change in focus to quality as opposed to quantity there are a number of products or applications that to date are still out of reach of conventional manufacturers in that certain items simply cannot be handled or produced economically by conventional printing equipment and forms processing apparatus. That is, where a small order for products containing multiple items or features is presented to a manufacturer, the traditional manufacturer would have to set up multiple pieces of fulfillment equipment as opposed to being able to run a multipart order through a single or very few pieces of equipment. The process is further exacerbated if the customer requires one or more specialty features be added to the business communication piece. In addition, where a consumer wants to procure a number of distinct items that are printed at a relatively high resolution and which have one or more specialty features in the product makes attainment of such products increasingly difficult for the manufacturer, as the product will typically exceed an economic threshold of the customer.

Scratch off type products are generally well known, and have historically been associated with certain industries and business segments, including for example the gaming industry. Exemplary products found in the gaming industry include instant win type of tickets and cards. In this type of embodiment, a prize or other information is printed on a card face and then the face is covered with an opaque coating that is removable, such as by scratching to reveal the underlying prize information.

As mentioned previously, typically, in order for small business owners to obtain such features on business communications that the owner intends to distribute, the business owner may be faced with having to order significant quantities of product, which may simply exceed the demands of the marketing campaign wishes to engage in or alternatively, leave the business owner with a large amount of unusable product, as the quantities exceed his or her customer and marketing database. In addition, the small business owner may be faced with paying a substantial premium in order to obtain the particular feature of interest.

What is needed therefore is a pressure sensitive intermediate presented with a scratch off coating in a configuration that can be produced economically by manufacturers of business communications and distributed in a manner that allows small business owners the ability to apply discrete label products in order to create customized marketing and promotional campaigns on a small or limited scale without having to pay significant premium or purchase large quantities of products.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that there is no available pressure sensitive intermediate product that can provide a scratch off type of product in a piggyback product configuration which may be used at a site remote from the business forms manufacturer. Such an assembly would enable small business owners to easily and readily add this type of product feature to their select business communications without the need of having the business communications manufacturer add the additional features at the production site and thus incrementally increase costs at the production site. In this manner, a small business owner can reward loyal customers or users of their products and services with prizes, by applying the piggyback scratch off label to their business communications or alternatively, provide all of the small business owner's users with inspirational, motivational or promotional offers.

In addition, such an offering would allow a small business owner to run promotions “at will” without having to guess at the types of quantities that may be needed from a manufacturer of business communications. This process thus allows the small business owner to achieve cost savings over having to order predefined quantities of scratch off products and thus be able to curtail or expand campaigns based on success or response rates. In this way, the small business owner is not left with an inventory of unusable products, in the event a campaign is not successful or alternatively, not have to obtain or order additional product at a premium in order to initiate or respond to a successful campaign.

In one exemplary embodiment, a pressure sensitive intermediate is described which has an opaque covering and includes a carrier web which has first and second faces and first and second transversely extending edges with a release coating provided on the first face. A series of lines of perforation are provided in the carrier web and each of the lines of perforation extends substantially perpendicular to the transversely extending edges. A pattern of pressure sensitive adhesive is applied to the first face of the release coating.

A substrate that has first and second faces and first and second transversely extending edges is provided with the second face being in contact with the pattern of pressure sensitive adhesive. The transversely extending edges run substantially parallel to the first and second transversely extending edges of the carrier web. The substrate includes a series of lines of perforation that extend substantially perpendicular to the transversely extending edges of the substrate and run substantially parallel to the series of perforations of the carrier web.

Continuing with a description of the presently described embodiment, a series of printed images is applied to the first face of the substrate, with the series of printed images including at least a first pattern of repeating similar images and at least a second pattern of images that is distinct from the first pattern. A removable opaque coating is applied over the series of the printed images. The removable opaque coating along with the series of perforations in each of the carrier web and the substrate define distinct pressure sensitive scratch off intermediate assemblies.

In a still further exemplary embodiment, an intermediate pressure sensitive roll assembly is described and includes a continuous release coated carrier web. The carrier web has a first face that is provided with a release material and a second uncoated face. The carrier web has a series of substantially equally spaced perforations that extend perpendicularly to a web travel direction. A pattern of pressure sensitive adhesive is applied to the first face of the carrier web; the pattern of adhesive extends parallel to the web travel direction.

Continuing with a discussion of the presently described embodiment, a continuous printable substrate is provided that has first and second faces with the second face applied over the pattern of pressure sensitive adhesive. The first face is printed with at least first, second and third images that are produced in random arrangements, the printable substrate is then provided with a series of regularly spaced perforation lines which separate each of the images from one another to create individual intermediate pressure sensitive assemblies. A removable opaque coating is applied over each of the printed images with the coating substantially concealing each of the printed images. The continuous release coated carrier web and the continuous printable substrate are wound into a roll to create a continuous intermediate scratch off pressure sensitive configuration that has a plurality of individual pressure sensitive assemblies.

In yet a still further exemplary embodiment, a package of distinct pressure sensitive intermediate roll assemblies is provided and includes a package, with the package including a first roll of pressure sensitive intermediates. The first roll includes an adhesive coated substrate that has a series of distinct printed portions to create individual label portions. Each of the printed portions preferably will have identical or matching imaging and each of the individual label portions is separated from one another by lines of perforation.

The currently described embodiment includes a second roll of pressure sensitive intermediates. The second roll includes an adhesive coated substrate that has a series of distinct printed portions to create individual label portions. Each of the printed portions will preferably have identical or matching imaging and the imaging is distinct from the printed portions on the first roll of pressure sensitive intermediates. Each of the individual label portions is separated from one another by lines of perforation.

The presently described embodiment includes a third roll of pressure sensitive intermediates. The third roll includes an adhesive coated substrate that has a series of distinct printed portions to create individual label portions. Each of the printed portions will preferably have identical, matching or related imaging and the imaging is distinct from the printed portions on the first and second rolls of pressure sensitive intermediates. Each of the individual label portions is separated from one another by lines of perforation. Each of the printed portions of the first, second and third rolls are provided with a removable opaque coating.

The package further includes at least a first series of partially printed business forms with each of the business forms having an area suitable for receiving at least one of the label portions from one of the first, second and third rolls.

The package of the foregoing embodiment may also include a second series of business forms that are distinct from the first series. In addition, the second series may be partially preprinted with information that matches indicia printed on the first series.

In any or each of the foregoing embodiments, the printing or imaging that appears of the substrate may be selected from a group that includes promotional, inspirational, motivational, sweepstakes, prizes, marketing, advertising and any combinations of the foregoing.

The printing that is provided on the surface of the substrate may be produced in a series of patterns or images. One of the patterns or images may appear substantially more frequently than others, for instance in a sweepstakes promotion, certain prizes may occur only once in a while in a distribution of products, whereas a motivational phrase or coupon may occur with regular or significantly greater frequency.

The opaque coating that is applied over the top of the printing or imaging may be applied in a shaped configuration such as geometric, or other configuration depending on the coating capabilities of the manufacturer in supplying the product to the customer.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of the pressure sensitive intermediate assembly of the present invention showing a series of individual label portions and supporting structure;

FIG. 2 provides a front view of the pressure sensitive intermediate assembly of the present invention showing a series of individual label portions illustrating printing or imaging provided on the face of the substrate;

FIG. 3 shows a series of pressure sensitive intermediate web assemblies each of which has distinct printing from the other web assemblies; and

FIG. 4 present a view of a package containing several pressure sensitive assemblies as well as business forms and an embossing tool for affixing the individual label portions to a business form assembly.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The invention described in the instant specification allows small business owners, social organizations, non-profit groups and the like to create business communications with a scratch off promotional offering through the use of an intermediate piggyback assembly that is provided, preferably in a continuous format. Through use of this unique configuration, small groups can avail themselves of a unique communication feature and better control the distribution of the communications without the necessity of having to order large quantities of product in order to fulfill a particular niche or opportunity.

As used herein the term “business communication” is used to refer to a printed or imaged piece, document or substrate that when used with the a laminate as described in the present invention will convey a particular message, image or provide information about a particular product or service that is available from the provider of such pieces or documents. Business communications, documents or pieces can include advertising, sales and marketing collateral and such other items used to convey information, and in connection with the present invention also include cards, certificates, tags, ticket, redemption coupons, labels, passes, badges and combinations of the foregoing.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering, laminating and the like. Typically, a product such as with the present invention is provided in an intermediate condition so that a user or downstream manufacturing point can add or manipulate the intermediate to create the final or desired end product, such as creating a finished business communication by adhering one of the piggyback scratch off label portions to a business communication.

The term “personalized information” refers to information that is printed or imaged onto a substrate or document which is generally variable or unique and which may change from label portion to label portion so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from label portion to label portion and may include a general description or body of information about particular products, services, places, etc. that may be of interest to the intended recipient and represents a standard message that the manufacturing or supplier wishes to convey to an end user or customer of the offering.

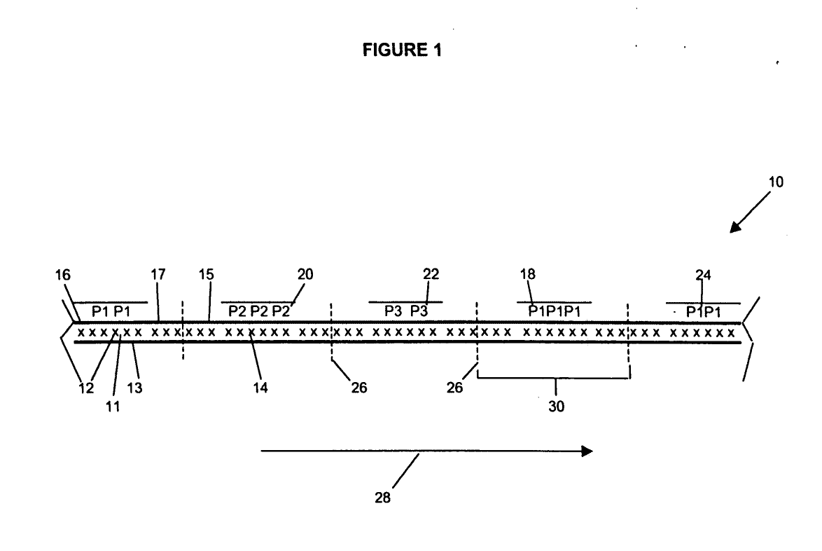

Reference is now directed to FIG. 1 which shows a cross section of a pressure sensitive web assembly produced in accordance with the present invention. The web assembly which is generally depicted by reference to numeral 10 and includes a carrier web 12, which is preferably a continuous web. The carrier web 12 has first and second faces 11 and 13 and first and second transversely extending edges which are shown in a later drawing. The first face 11, is preferably coated with a release material such as silicone, or alternatively may be a highly calendared web which has some light release properties.

A pattern of adhesive 14 and depicted by character references “XXX” is applied to the first face 11 of the carrier web 12. A continuous substrate 16 is provided and has first and second faces 15 and 17. The continuous substrate 16 will also have first and second transversely extending edges which are shown in later drawing FIGURES. The substrate 16 will preferably be a printable material such as a cellulosic based stock; however, synthetic films or metal foils may also be used.

Printing or imaging 18, 20 and 22 is applied to the first face 15 of the substrate 16. The printing 18, 20 and 22 shows three different patterns or images which are depicted in the drawing as “P1”, “P2” and “P3”. Also as shown in the drawing FIG. 1, pattern 18 appears significantly more than either of pattern two or three, 20 and 22 respectively. For example, if a sweepstakes promotion is the intent of the user of the product, printed pattern P1 or 18 may be a series of promotional messages, P2 or 20 may be a coupon or lesser prize and pattern P3 or 22 may be a prize of greater value.

The printing of the patterns of the web of material can be accomplished by any sort of conventional variable printing mechanism, such as an ink jet based system or laser printer which uses toner as the imaging media. The arrangement of the patterns will typically be predetermined by the user and may be programmed into the printing unit so that one pattern appears more regularly than the other patterns or alternatively a few or a select number of the prize pattern appears on the web. Placement of the patterns will generally occur in a substantially random arrangement or configuration.

FIG. 1 also shows a coating 24 that has been applied over each of the printed patterns 18, 20 and 22. While the coating 24 has been shown in a segmented arrangement, that is only covering the printed areas, it should be understood that the coating may be applied in a continuous manner. It is however preferable, that the coating substantially conceal the printing on the surface of the web so as to cover any prize information from early detection.

Also shown in FIG. 1 is a series of lines of perforations 26 which preferably occur in regularly spaced increments to define individual label portions. The lines of perforation will preferably cut through the substrate and carrier web such that the lines of perforation are substantially in alignment with one another and run generally perpendicular to the direction of web travel as illustrated by arrow 28. By providing the lines of perforations, the individual label portions 30 may then be separated from the web and other surrounding label portions allowing the user to apply individual label portions to business communication documents.

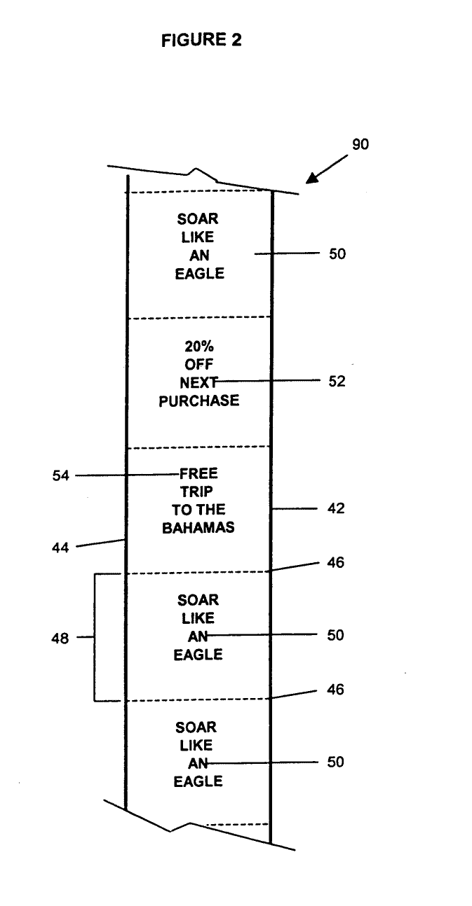

FIG. 2 shows the pressure sensitive web assembly of the present invention which is generally depicted by reference numeral 40. The web 40, as mentioned previously has first and second transversely extending sides 42 and 44. It should be understood that the carrier web as well as the printable substrate each have first and second transversely extending edges, and for simplicity purposes only, the edges of the printable substrate is shown.

The web 40 is provided with a series of regularly spaced lines of perforation 46 which separate the web 40 into individual label portions 48. The web 40 is shown with three patterns or printing or imaging 50, 52 and 54. Image 50 is shown as being a motivational phrase, while image 52 is presented as a promotional offering and image 54 is a prize offering that may be awarded as part of a sweepstakes promotion.

The printing of the first pattern 50 occurs more frequently than either of the other two patterns 52 and 54 and as shown in FIG. 2, each of the patterns are distinct from one another. Again, the printing patterns can be provided in a random configuration or can be printed on the web in a predetermined fashion. For example, printed pattern three can be printed at every 20^{th} spot, where as the second pattern can be printed every 9^{th} and 18^{th} spot and the first printed pattern printed in every remaining patterns so that the first pattern appears significantly more than either of the other two printed patterns that are provided on the web.

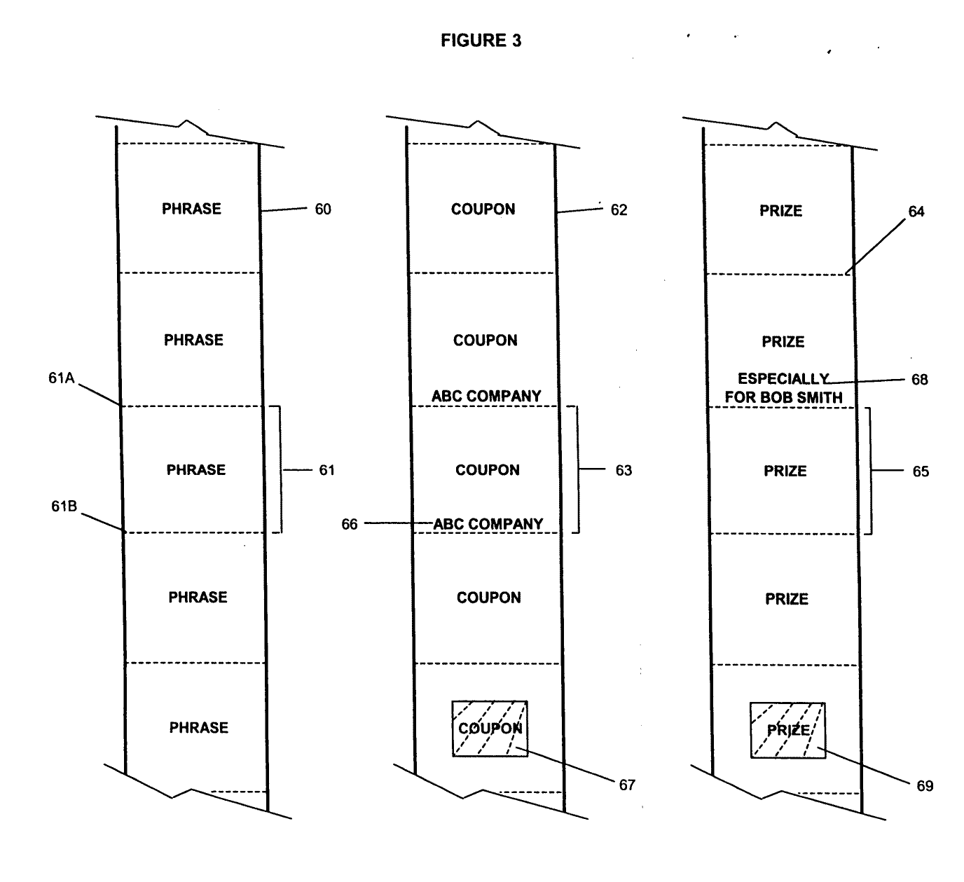

Reference is directed to FIG. 3 of the presently described embodiment which shows a plurality of pressure sensitive web intermediate assemblies 60, 62 and 64. Each of the intermediate web assemblies has been printed or imaged with textual information that is distinct from the other intermediate web assemblies, and designated by the terms “Phrase”, “Coupon” and “Prize”. In this manner, the customer can then select the frequency of prize awards, coupons and motivational or promotional phrases and randomization then is done manually by the individual utilizing the intermediate web assemblies. For convenience, it should be understood that the image or printing has not been provided with the opaque coating so that one may see the distinct printing that occurs one each web assembly.

It should also be understood that while textual information has been shown as being the printing on the face of the web assemblies, it should be understood that graphics may be used in combination with the text, or that graphics may be printed alone on the web assemblies or any combination of graphics and text may appear.

Each web 60, 62 and 64 as shown in FIG. 3 also has individual label portions, designated as 61, 63 and 65, respectively. The label portions on each of the web assemblies are defined by the lines of perforations, see for example reference numerals 61A and 61B that are provided on web 60. Generally, each of the label portions will be substantially equal so that prize containing label portions cannot be readily identified when compared with label portions presented on other web assemblies.

For purposes of illustration, coated areas are shown by reference numerals 67 and 69 on webs 62 and 64, respectively. The coated areas, shown in phantom are presented in a geometric pattern which is substantially quadrate in appearance. Other patterns are of course possible depending on the requirements of the end user and the capabilities of the manufacturer to produce the desired configuration.

It should be understood that while generally not shown in FIG. 3, each of the web intermediate assemblies 60, 62 and 64 will have the pressure sensitive construction as discussed in connection with the description provided along with FIG. 1 above.

Each of the label assemblies may also be provided with static or fixed printed information as shown by reference numeral 66 in connection with web intermediate assembly 62. Static or fixed information may include the name of the entity sponsoring or providing the promotion. In addition, select label portions as shown on web intermediate assembly 64 may be provided with additional personalized printing for specific customer applications, such as is represented by reference numeral 68. In addition to providing personalized information adjacent other printing, personalized information can be provided in connection with preparing individual phrases, promotions or prizes to further individualize the event of the sponsor.

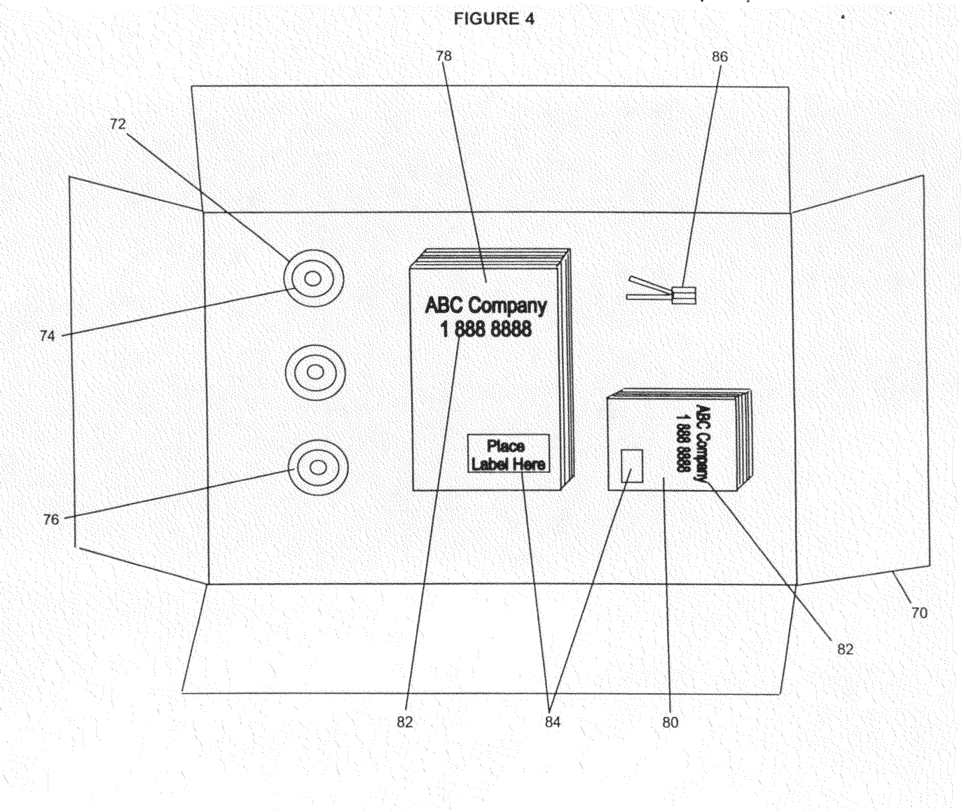

Attention is now directed to FIG. 4, which includes a further exemplary embodiment of the present invention. In this arrangement, a package 70 is provided for holding a number of items that may be offered to a customer of the present product or service. The package 70 will preferably be any sort of suitable shipping package, carton or envelope that can hold one or more elements for use in the present invention.

As shown in FIG. 4, the package holds three rolls of web intermediate assemblies 72, 74 and 76. The rolls of web intermediate assemblies 72, 74 and 76 may be those for example that were described in connection with the embodiments discussed in connection with FIG. 3, that is one roll carrying a motivational phrase, one carrying a promotional offering and still a further carrying a prize notification. By providing product in this configuration, not only can the small business owner create his or her own randomization sequence, but the product may be offered at a deeper discount by the manufacturer as there is no required computerized randomization of the printing sequence as may be required if only a single roll of web intermediate assemblies were provided in the package.

The package 70 also shows a first series of business forms 78 and a second series of business forms 80. Each of the business form sets 78 and 80 have been partially preprinted with information such as the company name and number of the sponsoring entity and as designated by reference numeral 82. The small business owner may take each of the form assemblies and further process the business forms such as by adding account information, personal greetings, product or service information and the like. The business form sets have also been provided with suggested areas of where to apply labels from each of the intermediate web assemblies as represented by reference numeral 84.

The package 70 of the present invention is also shown with an embossing type tool 86 which may aid the customer in applying the individual label portions to each of the series of business forms.

It will thus be seen according to the present invention a highly advantageous pressure sensitive intermediate assembly having a removable coating over one or more printed images has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. In combination with a set of business communications to be individually labeled, a pressure-sensitive label intermediates system, comprising;
a. a plurality of carrier webs;
b. each of said webs carrying a plurality of labels having indicia printed thereon, said webs being coated with a release material, and said labels being individually releasably adhered to said carrier webs with a pressure-sensitive adhesive; and
c. the labels of each of said carrier webs carrying at least one of a plurality of types of recurring indicia, the recurrence rate of said indicia being different for each carrier web;
d. whereby a user of said labels for labeling said business communications can produce a wide variety of labeling sequences with a minimum of carrier webs.

2. The system of claim 1, in which at least one of said webs includes labels with indicia obscured by a removable coating.

3. The system of claim 1, which includes at least one of said webs in which all labels have the same indicia.

4. The system of claim 1, which includes at least one web in which at least one label having indicia different from the other labels on that web recurs in a random sequence.

5. The system of claim 1, which includes at least one web in which at least one label having indicia different from the other labels on that web recurs in a non-random sequence.
